(19) United States
(12) Patent Application Publication
(10) Pub. No.: US 2012/0218233 A1
(43) Pub. Date: Aug. 30, 2012

(54) TERMINAL HAVING ROTARY BUTTON

(75) Inventors: In Seong CHUN, Seoul (KR); Min Kwon KANG, Seoul (KR); Byoung Soo NOH, Seoul (KR)

(73) Assignee: PANTECH CO., LTD., Seoul (KR)

(21) Appl. No.: 13/401,219

(22) Filed: Feb. 21, 2012

(30) Foreign Application Priority Data
Feb. 25, 2011 (KR) 10-2011-0017324

(51) Int. Cl. G06F 3/01

(52) U.S. Cl. 345/184

(57) ABSTRACT

A terminal includes a rotary button bracket including a dial button and a penetrating member; a housing including a penetrating hole and a click notch, the click notch being disposed around the penetrating hole; and a click bracket having a click protrusion and a planar portion, the click protrusion being configured to engage the click notch. The planar portion is arranged proximate to the penetrating hole, and the penetrating member is coupled to the click bracket.

### CROSS-REFERENCE TO RELATED APPLICATION

This application claims priority from and the benefit under 35 U.S.C. §119(a) of Korean Patent Application No. 10-2011-0017324, filed on Feb. 25, 2011, which is hereby incorporated by reference for all purposes as if fully set forth herein.

### BACKGROUND

1. Field

The following disclosure relates to a terminal having a rotary button.

2. Discussion of the Background

Portable electronic devices, such as mobile phones, digital cameras, MP3 players, and the like, have a variety of components to provide user interfaces to receive user's manipulation input, including, for example, a rotary button.

A rotary button may be configured to perform on/off operation or mode switching according to a manipulation of a user for the rotary button disposed on the exterior housing of an electronic device.

As demand for thinner and smaller electronic devices with water-resistant features for durability during outdoor activities increases, demands for electronic devices having thinner rotary buttons and a water-resistant property may also increase.

### SUMMARY

Exemplary embodiments of the present invention provide a terminal having a rotary button. The terminal may provide a waterproof function and may allow a manipulation of the rotary button to be recognized by a user by providing a click feeling during a rotation operation of a rotary button.

Additional features of the invention will be set forth in the description which follows and, in part, will be apparent from the description, or may be learned by practice of the invention.

An exemplary embodiment of the present invention provide a terminal includes a rotary button bracket including a dial button and a penetrating member; a housing including a penetrating hole and a click notch, the click notch being disposed around the penetrating hole; and a click bracket having a click protrusion and a planar portion, the click protrusion being configured to engage the click notch. The planar portion is arranged proximate to the penetrating hole, and the penetrating member is coupled to the click bracket.

An exemplary embodiment of the present invention provide a device having a rotary button, including a rotary button bracket including a dial button and a fastening member; a is housing having a penetrating hole and a click notch, the click notch being disposed on an inner surface around the penetrating hole; a click bracket having a click protrusion and a thin-plate shaped planar portion, the click protrusion being configured to engage the click notch; an operation bracket having a switch-controlling protrusion, the switch-controlling protrusion being configured to connect to a switch according to a rotation; and a fastener to couple the thin-plate shaped planar portion to the housing to seal the penetrating hole, the fastener being coupled to the fastening member.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view illustrating a terminal which has been exposed by removing the back cover according to an exemplary embodiment of the present invention.

FIG. 2 is a bottom view illustrating a terminal according to an exemplary embodiment of the present invention.

FIG. 3 is a cross-sectional view taken along the line A-A of FIG. 1 according to an exemplary embodiment of the present invention.

FIG. 4 is an exploded perspective view illustrating a terminal according to an exemplary embodiment of the present invention.

FIG. 5 is an enlarged perspective view illustrating a fastening member in a rotary button bracket constituting a terminal according to an exemplary embodiment of the present invention.

FIG. 6 is an enlarged perspective view illustrating a click bracket of a terminal according to an exemplary embodiment of the present invention.

FIG. 7 is an enlarged perspective view illustrating a button operation bracket of a terminal according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, XZZ, YZ, X).

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

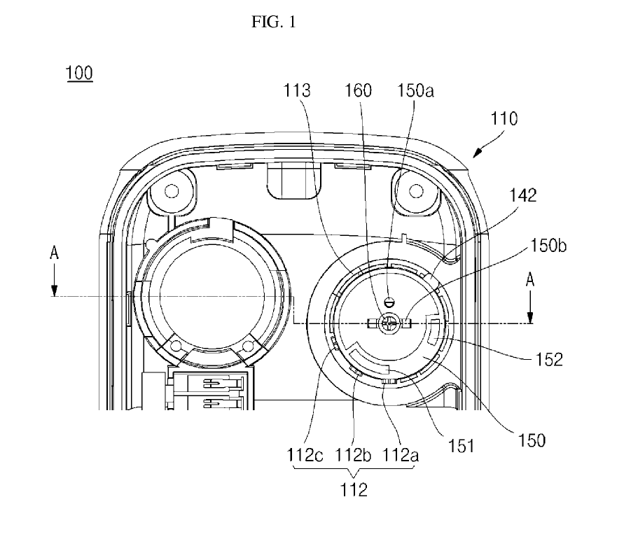

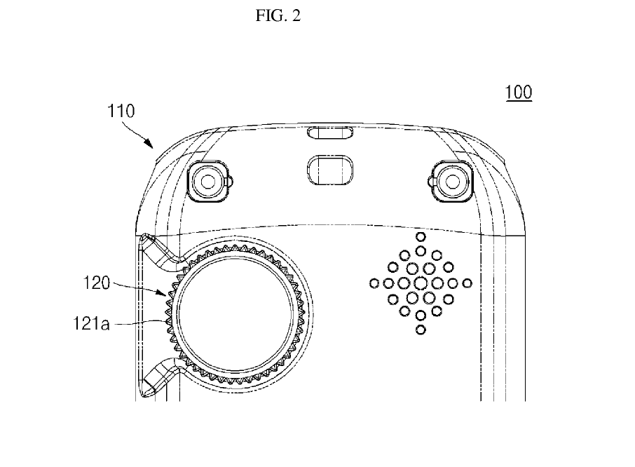

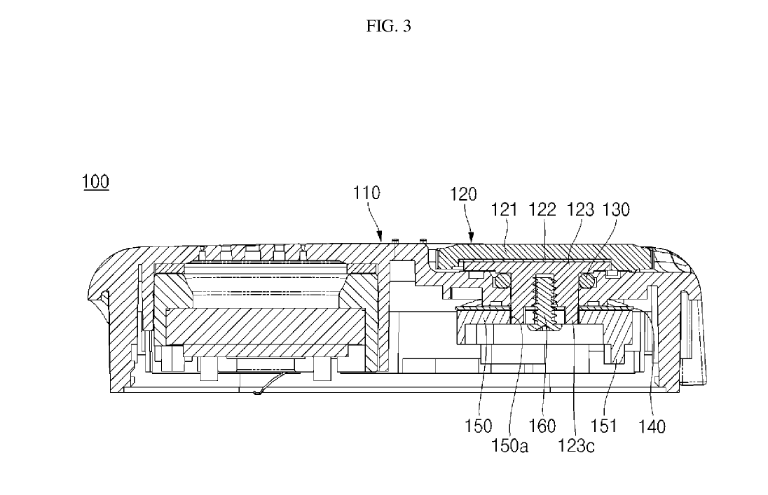

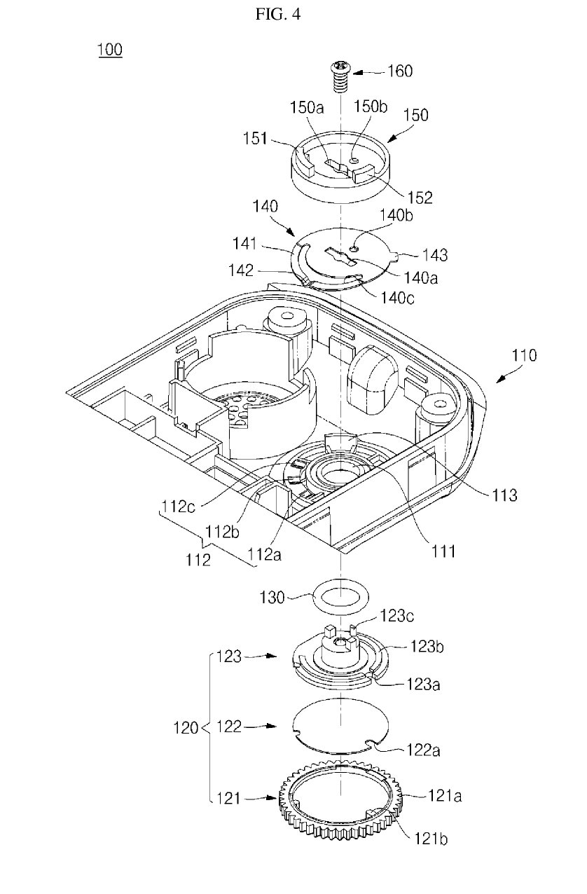

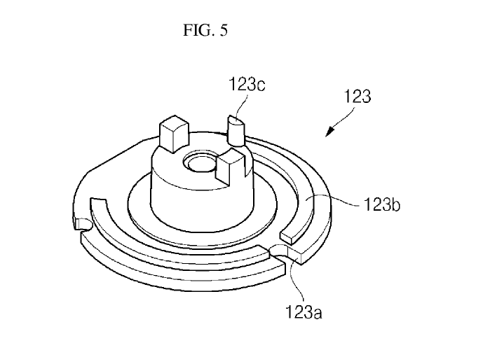

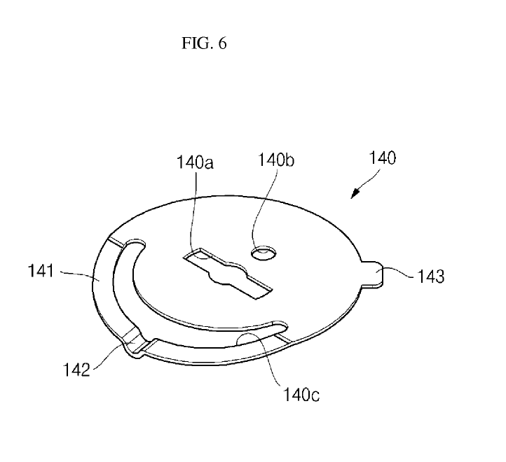

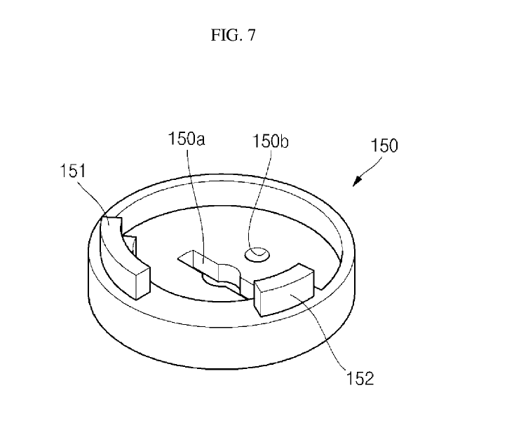

FIG. 1 is a plan view illustrating a terminal which has been exposed by removing the back cover according to an exemplary embodiment of the present invention, FIG. 2 is a bottom view illustrating a terminal according to an exemplary embodiment of the present invention, FIG. 3 is a cross-sectional view taken along the line A-A of FIG. 1 according to an exemplary embodiment of the present invention, FIG. 4 is an exploded perspective view illustrating a terminal according to an exemplary embodiment of the present invention, FIG. 5 is an enlarged perspective view illustrating a fastening member in a rotary button bracket of a terminal according to an exemplary embodiment of the present invention, FIG. 6 is an enlarged perspective view illustrating a click bracket of a terminal according to an exemplary embodiment of the present invention, and FIG. 7 is an enlarged perspective view illustrating a button operation bracket of a terminal according to an exemplary embodiment of the present invention.

Referring to FIG. 1, FIG. 2, FIG. 3, FIG. 4, FIG. 5, FIG. 6, and FIG. 7, the terminal 100 includes a housing 110, a rotary button bracket 120, a click bracket 140 and an operation bracket 150. The terminal 100 may include an O-ring 130 and a fastening screw 160.

The housing 110 forms an outer appearance of the terminal 100 and may protect internal elements or components from external forces. The housing 110 may include an internal space to enclose various elements or components for operating the terminal 100.

The housing 110 may include a penetrating hole 111 to which the rotary button bracket 120 may penetrate. The housing 110 may be coupled or connected to the rotary button bracket 120 through the penetrating hole 111. Electrical signals may be generated if a user manipulates the rotary button bracket 120.

A click notch 112 may be disposed on the inner surface of the housing 110 around the penetrating hole 111. The click notch 112 may include click notches 112a, 112b, and 112c spaced apart from each other with an interval separating one click notch from the next click notch. The click notches 112a, 112b, and 112c may be arranged by engraving the housing 110 in a thickness direction of the housing 110 (the direction parallel to the axis of the penetrating hole 111). For example, as shown in FIG. 1 and FIG. 4, the terminal 110 may include the click notch 112 having a first click notch 112a, a second click notch 112b, and a third click notch 112c, but the number of the click notches 112 is not limited as such. The click notch 112 may be coupled or connected to the click bracket 140. The click bracket 140 may rotate with respect to the click notch 112 while contacting the inner surface of the housing 110 on which the click notch 112 is disposed. If the click bracket 140 is matched with the click notch 112, a click feeling may be transmitted to a user by resilience of a click protrusion 142 of the click bracket 140. Therefore, the user may manipulate the rotary button bracket 120 and recognize manipulation of the rotary button bracket 120 due to click notch 112 generating the click feeling.

Further, the housing 110 may include a rotation stopper protrusion 113 protruding toward the inside of the housing 110. The rotation stopper protrusion 113 may be disposed around the penetrating hole 111 and may be disposed apart from the click notch 112. When the click bracket 140 rotates, the rotation stopper protrusion 113 and a rotation stopper 143 of the click bracket 140 may stop the rotation of the click bracket 140, thereby preventing the click bracket 140 from rotating by an angle greater than a predetermined angle.

The rotary button bracket 120 may be coupled or connected to an internal component of the terminal 100 from the outside through the penetrating hole 111. The rotary button bracket 120 may be coupled to the housing 110 while penetrating the penetrating hole 111 from the outside of the housing 110. The rotary button bracket 120 may be exposed to the user to allow the user to manipulate the operation of the rotary button bracket 120. As the result of the user's manipulation, the rotary button bracket 120 may rotate around a rotation axis perpendicular to the plane of the penetrating hole 111. Further, the rotary button bracket 120 may be coupled or connected to the click bracket 140 and the operation bracket 150 at the inner space of the housing 110 via the fastening screw 160. Therefore, the rotary button bracket 120 may be stably coupled to the housing 110.

The rotary button bracket 120 may include a dial button 121, a middle member 122, and a fastening member 123. The dial button 121 may be a gear-shaped rotary dial.

The dial button 121 may include a gear-shaped portion 121a arranged around the exterior of the dial button 121 and may be rotated by the user's manipulation. The gear-shaped portion 121a may encircle the entire dial button 121, such as shown in FIG. 4, but may be arranged on only a portion of the dial button 121 to facilitate the user's manipulation. Further, the dial button 121 may have an internal space, and a fastening protrusion 121b may be disposed at a portion of the internal space, thereby allowing the middle member 122 and the fastening member 123 to be coupled or connected to the dial button 121.

The middle member 122 may be received into the internal space of the dial button 121 and may be coupled or connected to the fastening protrusion 121b through a fastening groove 122a arranged at a portion of the periphery of the middle member 122. The middle member 122 may support stable fastening between the dial button 121 and the fastening member 123.

Referring to FIG. 4 and FIG. 5, a lower portion of the fastening member 123 may be inserted into the internal space of the dial button 121 and may be coupled or connected to the fastening protrusion 121b through fastening grooves 123a arranged at a portion of the periphery of the fastening member 123. As the dial button 121 rotates, the fastening member 123 may rotate, since the fastening grooves 123a maintain the position relative to the fastening protrusion 121b. The fastening member 123 may include a rotation guide 123b arranged on an upper surface of the lower portion thereof. If the fastening member 123 rotates with respect to the housing 110 while the fastening member 123 is in contact with the bottom surface of the housing 110, the rotation guide 123b may guide the rotation of the fastening member 123 along a rotational path. The fastening member 123 may include penetrating protrusions 123c arranged at the upper surface of a penetrating member 123d. The penetrating member 123d may include a fixing member 123e. The screw 160 may be connected to the fixing member 123e such that the fixing member 123e and the screw 160 may connect the dial button 120, the click bracket 140, and the operation bracket 150. Further, the screw 160 and the fixing member 123e may be replaced with other types of fasteners. The penetrating protrusions 123c may penetrate the click bracket 140 and the operation bracket 150 disposed within the housing 110. Therefore, as the rotary button bracket 120 including the fastening member 123 rotates, the click bracket 140 and the operation bracket 150 may also rotate.

The O-ring 130 may be disposed between the housing 110 and the rotary button bracket 120. The O-ring 130 may be disposed at the interior side of rotation guide 123b of the fastening member 123, thereby sealing the gap between the fastening member 123 and the housing 110. The O-ring 130 may prevent moisture from permeating into the housing 110, thereby improving water-resistance. As used in this disclosure, “water-resistance” may refer to improving a device or structures resistance to damage caused by incidental water contact, or water-proofing according to an industry or commercial standard.

Referring to FIG. 4, FIG. 5, and FIG. 6, the click bracket 140 may be coupled to the housing 110 from the inside thereof. The click bracket 140 may include a first hole 140a and a second hole 140b. The second hole 140b may be coupled to penetrating protrusions 123c disposed on the fastening member 123 of the rotary button bracket 120. Therefore, as the rotary button bracket 120 rotates, the click bracket 140 also rotates.

The click bracket 140 may include a plate portion. Specifically, the click bracket 140 may include planar surface portion and may be coupled to the housing 110 while making a surface contact. Further, the other side of the click bracket 140 may be coupled to the operation bracket 150 while making a surface contact. Thus, the click bracket 140 be tightly coupled to the housing 110 and the operation bracket 150 to reduce or eliminate a gap between the housing 110 and the operation bracket 150 via the fastening screw 160. Therefore, the click bracket 140 may prevent or reduce the risk of moisture permeating into the housing 110 in conjunction with the O-ring 130, thereby providing water-resistance. The click bracket 140 may include water-resistant material.

The click bracket 140 may include an elastic portion 141. The elastic portion 141 may be disposed at a portion of the periphery of the click bracket 140. A third hole 140c may be provided along the periphery in the interior side of the elastic portion 141. The elastic portion 141 may be separated from other regions of the click bracket 140 through the third hole 140c. The elastic portion 141 may be bent with respect to the other regions of the click bracket 140. If the click bracket 140 is disposed between the housing 110 and the operation bracket 150, the center of the click bracket 140 may be coupled roughly at the centers of the housing 110 and the operation bracket 150 via a fastening screw 160 to allow the elastic portion 141 to move to a certain extent. Further, if the elastic portion 141 is coupled to the housing 110, the elastic portion 141 may contact an inner portion of the housing 110 on which the click notch 112 is disposed. Therefore, the elastic portion 141 may have a resilience to generate the click feeling in conjunction with the click notch 112 as the click bracket 140 rotates with the dial button 121.

Further, the click bracket 140 may include a click protrusion 142 protruding from a portion of the elastic portion 141. The click protrusion 142 may be disposed to be downwardly protruding to face the housing 110. As the click bracket 140 rotates, the click protrusion 142 may be matched with the click notch 112 of the housing 110 while rotating on a surface of the housing 110. If the click protrusion 142 is matched with the click notch 112, a click feeling may be transmitted to the user by the resilience of the elastic portion 141, thereby allowing the user to receive feedback while manipulating the rotary button bracket 120. For example, the click bracket 140 may be made of a material having rigidity and elasticity and may be selected from SUS 301 and SUS 304 or a combination thereof.

The click bracket 140 may include a rotation stopper 143 protruding from the edge thereof. The distance from the center of the click bracket 140 to the rotation stopper 143 may be longer than the distance from the center of the click bracket 140 to the rotation stopper protrusion 113 of the housing 110. Therefore, if the click bracket 140 rotates by an angle greater than a reference angle, the rotation stopper 143 of the click bracket 140 may contact the rotation stopper protrusion 113, thereby preventing the click bracket 140 from rotating beyond the reference angle.

Referring to FIG. 4, FIG. 5, FIG. 6, and FIG. 7, the operation bracket 150 may be coupled to a portion of the click bracket 140. The operation bracket 150 may be coupled to the click bracket 140, the housing 110 and the rotary button bracket 120 via the fastening screw 160. The operation bracket 150 may include a first hole 150a and a second hole 150b arranged in proximity to the center of the operational bracket 150. The first hole 150a and the second hole 150b may receive the penetrating protrusions 123c of the rotary button bracket 120. Therefore, as the rotary button bracket 120 rotates, the operation bracket 150 also rotates to perform its operation.

The operation bracket 150 may include one or more protrusions 151 and 152 disposed on the edge of its upper surface. As the operation bracket 150 rotates, the first protrusion 151 and the second protrusion 152 also rotate such that the protrusions 151 and 152 of the operation bracket 150 are connected to or disconnected from a switch (not shown). In a case where the first protrusion 151 and the second protrusion 152 are connected to the switch is denoted by ‘1’ and a case where the first protrusion 151 and the second protrusion 152 are disconnected from the switch is denoted by ‘0,’ four control signals represented by (0,0), (0,1), (1,0) and (1,1) may be applied to the switch. For example, if the first protrusion 151 and the second protrusion 152 are connected to the switch, a first control signal (1,1) may be input to the switch. If the first protrusion 151 is connected to the switch but the second protrusion 152 is not connected to the switch, a second control signal (1,0) may be input to the switch. Therefore, the switch may perform operations corresponding to the four control signals according to the rotation of the operation bracket 150. If the operation bracket 150 includes one protrusion, the switch may perform two operations corresponding to each of two control signals, respectively, and if the operation bracket 150 includes three protrusions, the switch may perform up to eight operations corresponding to each of eight control signals, respectively. The protrusions 151 and 152 may be referred to as switch controllers.

The fastening screw 160 may sequentially penetrate the centers of the operation bracket 150, the click bracket 140, the housing 110 and the rotary button bracket 120. The fastening screw 160 may be coupled to the operation bracket 150, the click bracket 140, the housing 110 and the rotary button bracket 120. The fastening screw 160 may be coupled to the rotary button bracket 120 while penetrating the first hole 150a of the operation bracket 150, the first hole 140a of the click bracket 140 and the penetrating hole 111 of the housing 110. The operation bracket 150, the click bracket 140, the housing 110 and the rotary button bracket 120 may be assembled together by the fastening screw 160, thereby preventing the operation bracket 150, the click bracket 140, the housing 110 and the rotary button bracket 120 from being loosened from each other due to rotation-operations of the rotary button bracket 120.

As described above, the click bracket 140 may have a thin-plane shape and may be coupled to the housing 110 while making a surface contact with the housing 110 and the operation bracket 150. Further, the click bracket 140 and the rotary button bracket 120 may be assembled with the housing 110 via the fastening screw 160, thereby providing water-resistance. Further, the terminal 100 may further include the O-ring 130 provided in the rotary button bracket 120, thereby providing the water-resistance.

The terminal 100 may include the click notch 112 provided within the housing 110. Further, the elastic portion 141 and the click protrusion 142 may be provided in the click bracket 140 coupled to the penetrating protrusions 123c of the rotary button bracket 120. Thus, the user may recognize a click feeling by resilience of the elastic portion 141 when the click protrusion 142 is engaged with the click notch 112.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a rotary button bracket comprising a dial button and a penetrating member;
a housing comprising a penetrating hole and a click notch, the click notch being disposed around the penetrating hole; and
a click bracket having a click protrusion and a planar portion, the click protrusion being configured to engage the click notch,
wherein the planar portion is arranged proximate to the penetrating hole, and
the penetrating member is coupled to the click bracket.

2. The terminal of claim 1, further comprising an operation bracket having a switch controller, the switch controller being configured to control a switch.

3. The terminal of claim 1, wherein the click bracket comprises an elastic portion to generate a feedback when the click protrusion is engaged in the click notch, and the click protrusion is disposed on the elastic portion.

4. The terminal of claim 2, further comprising a fastening member to couple the click bracket and the operation bracket to the housing.

5. The terminal of claim 4, wherein the rotary button bracket comprises a fixing member to receive the fastening member.

6. The terminal of claim 2, wherein the penetrating member comprises a penetrating protrusion,
the click bracket comprises a first hole,
the operation bracket comprises a second hole, and
the penetrating protrusion penetrates the first hole and the second hole to transmit a rotational force of the rotary button bracket to the click bracket and the operational bracket.

7. The terminal of claim 1, wherein the planar portion is made of a water-resistant material.

8. The terminal of claim 1, wherein the click bracket further comprises a rotation stopper disposed at a periphery of the click bracket, and
the housing comprises a rotation stopper protrusion to prevent a rotation of the click bracket if the rotation stopper contacts the rotation stopper protrusion.

9. The terminal of claim 1, wherein the rotary button bracket comprises a rotation guide to guide a rotation of the rotary button bracket.

10. The terminal of claim 9, wherein the rotary button bracket comprises a receiving groove configured to receive an O-ring to seal a gap between the rotary button bracket and the housing, the receiving groove being located between the penetrating member and the rotation guide.

11. A device having a rotary button, comprising:
a rotary button bracket comprising a dial button and a fastening member;
a housing having a penetrating hole and a click notch, the click notch being disposed on an inner surface around the penetrating hole;
a click bracket having a click protrusion and a thin-plate shaped planar portion, the click protrusion being configured to engage the click notch;
an operation bracket having a switch-controlling protrusion, the switch-controlling protrusion being configured to connect to a switch according to a rotation; and
a fastener to couple the thin-plate shaped planar portion to the housing to seal the penetrating hole, the fastener being coupled to the fastening member.

12. The device of claim 11, wherein the fastening member comprises one or more penetrating protrusions to rotate the click bracket and the operation bracket, the click bracket comprises one or more first holes to receive the one or more penetrating protrusions, and the operation bracket comprises one or more second holes to receive the one or more penetrating protrusions.

13. The device of claim 11, wherein the click bracket comprises an elastic portion to generate a click feedback when the click protrusion is engaged in the click notch, and the click protrusion is disposed on the elastic portion.

14. The device of claim 12, wherein the click bracket comprises a hole disposed between the elastic portion and the thin-plate shaped planar portion.

15. The device of claim 11, wherein the dial button comprises a gear-shaped portion disposed around the periphery of the dial button.

16. The device of claim 11, wherein the dial button comprises a fastening protrusion to rotate the fastening member according to a rotation of the dial button.

17. The device of claim 11, wherein the rotary button bracket comprises a middle member disposed between the dial button and the fastening member.

18. The device of claim 11, wherein the fastening member comprises a penetrating member, a rotation guide, and a fastening groove, the fastening groove being coupled to a fastening protrusion of the dial button.

19. The device of claim 18, wherein the fastening member comprises a receiving groove configured to receive an O-ring to seal a gap between the fastening member and the housing, the receiving groove being located between the penetrating member and the rotation guide.

20. The device of claim 11, wherein the thin-plate shaped planar portion is made of a water-resistant material.
